(19) United States
(12) Patent Application Publication
(10) Pub. No.: US 2014/0271018 A1
(43) Pub. Date: Sep. 18, 2014

(54) FORKED VEHICLE AND A METHOD AND AN ASSEMBLY FOR TRANSPORTING A FORKED VEHICLE

(71) Applicant: THE RAYMOND CORPORATION, Greene, NY (US)

(72) Inventors: Michael G. Field, Lansing, NY (US); Brian M. Warner, Oxford, NY (US); John B. Kirk, Greene, NY (US)

(73) Assignee: The Raymond Corporation, Greene, NY (US)

(21) Appl. No.: 13/826,211

(22) Filed: Mar. 14, 2013

(51) Int. Cl. B60P 3/073; B60P 7/06; B60P 1/44; B66F 9/065

(52) U.S. Cl. CPC B60P 3/073; B66F 9/065; B60P 7/06; B60P 1/44
USPC 410/7; 254/2 R; 414/373

(57) ABSTRACT

A forked vehicle forms part of an assembly including a transporting vehicle having a powered lift gate. The forked vehicle includes a releasable grip securing the forked vehicle relative to the lift gate. The releasable grip is fixed relative to one of the lift gate and the forked vehicle and engages the other of the lift gate and forked vehicle to secure the forked vehicle relative to the lift gate.

### CROSS REFERENCES TO RELATED APPLICATIONS

Not Applicable

### STATEMENT REGARDING FEDERALLY SPONSORED RESEARCH

Not Applicable.

### BACKGROUND OF THE INVENTION

The present invention relates to forked vehicles, such as pallet trucks, lift trucks, and the like, and more particularly to methods and assemblies for transporting a forked vehicle.

Transportation of loads on pallets does not end when a truck trailer containing loaded pallets arrives at a loading dock. The loaded pallet must be unloaded from the trailer onto the loading dock. Moving these loads typically requires a forked vehicle, such as a fork lift or pallet truck. Unless equipment is available at the loading dock to unload the trailer, the delivering driver must bring the forked vehicle to the loading dock on the truck trailer.

In some cases, the pallet transport equipment is carried inside the trailer with the loaded pallets. Carrying a fork lift or pallet truck in the trailer takes up valuable space that could be used to transport one or more loaded pallets. Moreover, the forked vehicle must be properly secured in the trailer to ensure that the forked vehicle, pallet loads in the trailer, and the trailer are not damaged as a result of road motion, such as sudden stops by the trailer.

In other cases, the pallet transport equipment is attached to the exterior of the trailer, such as disclosed in U.S. Pat. No. 6,572,322. The system disclosed in U.S. Pat. No. 6,572,322 requires a specially designed powered lift truck that can lift itself off of the ground. Once lifted off of the ground, the lift truck must be manually secured to the trailer. Moreover, once secured to the trailer the lift truck extends a large distance behind the trailer limiting maneuverability of the trailer.

Therefore, a need exists for a method and assembly for easily transporting a forked vehicle that does not take up valuable trailer space without limiting maneuverability of the trailer.

### SUMMARY OF THE INVENTION

The present invention generally provides a forked vehicle, such as a pallet truck, adapted for being transported by a transporting vehicle. In one aspect, the present invention provides a forked vehicle including a frame with at least one fork extending from the frame. A releasable grip extends from at least one of the frame and the at least one fork. The releasable grip is engagable with a lift gate of a transporting vehicle to secure the forked vehicle relative to the lift gate.

In another aspect, the forked vehicle forms part of an assembly including a transporting vehicle having a powered lift gate. A forked vehicle having a releasable grip securing the forked vehicle relative to the lift gate. The releasable grip is fixed relative to one of the lift gate and the forked vehicle, and the releasable grip engages the other of the lift gate and forked vehicle to secure the forked vehicle relative to the lift gate.

In yet another aspect, the present invention provides a method of transporting a forked vehicle. The method includes the steps of inserting at least one fork of a forked vehicle into a receiving slot fixed to a transporting vehicle, and securing the forked vehicle relative to the transporting vehicle by actuating a releasable grip.

These and still other aspects of the present invention will be apparent from the description that follows. In the detailed description, a preferred example embodiment of the invention will be described with reference to the accompanying drawings. This embodiment does not represent the full scope of the invention; rather the invention may be employed in other embodiments. Reference should therefore be made to the claims herein for interpreting the breadth of the invention.

### BRIEF DESCRIPTION OF THE DRAWINGS

FIG. 1 is a side perspective view of a forked vehicle incorporating the present invention;

FIG. 2 is a sectional view along line 2-2 of FIG. 1;

FIG. 3 is a rear perspective view the material handling vehicle of FIG. 1 secured to a lift gate of a transporting vehicle;

FIG. 4 is a side view of the tube of FIG. 2;

FIG. 5 is a sectional view along line 5-5 of FIG. 4;

FIG. 6 is a top perspective exploded view of another embodiment incorporating the present invention;

FIG. 7 is a top perspective collapsed view of the embodiment shown in FIG. 6;

FIG. 8 is a schematic view of an electrical systems of the transporting vehicle and forked vehicle of FIG. 3.

### DETAILED DESCRIPTION OF THE PREFERRED EXAMPLE EMBODIMENT

The preferred example embodiment will be described in relation to a non-powered hydraulic pallet truck and a transporting vehicle having a powered lift gate. However, the present invention is equally applicable to other types and styles of powered and non-powered forked vehicles, such as lift trucks, that can be transported by the transporting vehicle.

A pallet truck, in accordance with an example embodiment of the present invention, is generally shown in FIG. 1. The vehicle 10 generally includes a frame body 12 and a fork assembly 14 rigidly fixed to the frame body 12. The frame body 12 is supported by a pair of steer wheels 16. A hydraulic cylinder interposed between the steering wheels and frame body 12 supports the frame body 12 above the wheels 16. A steer handle 20 extends upwardly from the frame body 12 and is used to turn the wheels when steering the vehicle 10.

The handle 20 is pivotally attached to the frame body 12 for pivotal movement about a horizontal axis and coupled to a manual hydraulic pump 22 in fluid communication with the hydraulic cylinder 18. Pivotal movement of the handle 20 actuates the hydraulic pump 22 which pumps hydraulic fluid into the hydraulic cylinder to raise the frame body 12, and thus the fork assembly 14. Preferably, the handle 20 is foldable over the frame body 12 to minimize the pallet truck height during transport. In one embodiment, the handle 20 includes a hinge 24 connecting an upper portion 26 of the handle 20 to a lower portion 28 of the handle allowing the handle to fold over the frame body 12. Alternately, the upper portion 26 of the handle 20 is separable from the lower portion 28, such as by removing a hinge pin forming part of the hinge 24.

In the example embodiment, the fork assembly 14 includes a pair of forks 30, each fork 30 having a distal fork end 32 and a proximal fork end 34. The proximal end 34 of each fork is rigidly fixed to the truck body 12, such as by welding. As is known in the art, a fork trail assembly 38 disposed in the distal fork end 32 of each fork 30 supports the fork distal end 32 as the fork assembly 14 is raised by the hydraulic cylinder 18.

In a preferred embodiment shown in FIGS. 1-5, each fork 30 includes a releasable grip 36 that engages a transporting vehicle 42, such as a semi-trailer, box truck, and the like, securing the pallet truck 10 to the transporting vehicle 42. As shown in FIGS. 2, 4, and 5, the releasable grip 36 in each fork 30 includes a pin 44 biased outwardly from each fork side 47 by a spring 50. A cable 49 connected to each pin 44 and extending through the fork 30 to the frame body 12 is pulled by an operator to retract the pin 44 into the fork 30. A catch can be provided that holds the pin 44 in the retracted position when the pallet truck 10 is not being transported by the transporting vehicle 42 to prevent the pins 44 from catching on pallets being transported on the pallet truck 10. Although the releasable grip 36 preferably forms part of the fork 30, the releasable grip can form part of the body frame 12 without departing from the scope of the invention.

The transporting vehicle 42 in the preferred embodiment shown in FIGS. 3-5 is adapted to include receiving slots 46 receiving the forks 30 of the pallet truck. The slots 46 are rectangular tubes 48 fixed, such as by welding, to a powered lift gate 52 mounted to the transporting vehicle 42. Apertures 56 formed in the tube sides 58 receive the pins 44 of the releasable grip 36 to prevent the forks 30 from slipping out of the tubes 48, thus securing the pallet truck 10 to the lift gate 52, and thus the transporting vehicle 42. Once the pallet truck 10 is secured to the transporting vehicle 42, the pallet truck handle 20 is folded over the pallet truck frame body 12 to minimize the height of the pallet truck 10. Advantageously, minimizing the height of the pallet truck reduces the distance the pallet truck 10 extends rearwardly beyond the transporting vehicle 42 when the lift gate 52 rotates the pallet truck 10 upon operation of the lift gate 52. Although in a preferred embodiment, the releasable grip 36 includes pins 44 extending from the forks 30 into apertures 56 formed in the tubes 48, the parts of the releasable grip can be reversed with the pins mounted to the tubes and extending into apertures formed in the forks without departing from the scope of the invention. Moreover, although biased pins 44 are described, biased and retractable pawls extending from either the pallet truck 10 and frictionally engaging inner surfaces of the tubes 48, or vice versa, can be used without departing from the scope of the invention.

As shown in FIGS. 4 and 5, preferably, the apertures 56 formed in the tube sides 58 and receiving the pins 44 are elongated to provide a second releasable grip. Advantageously, the elongated apertures 56 allow vertical movement of the forks 30 in the tubes 48 to wedge the forks 30 in the tubes 48 releasably gripping the forks to the tubes 48. In particular, once the pallet truck 10 is secured to the lift gate 52 by the pins 44 received in the apertures 56, an operator raises the fork assembly 14 to engage the forks 30 with an upper surface 62 of the tubes 48 and further secure the forks 30 in the tubes 48. Advantageously, this second releasable grip prevent the forks 30 from rattling inside the tubes 48 to prevent wear from vibrations or fork damage from sudden shocks.

In another embodiment shown in FIGS. 6 and 7, the tubes 48 described above can be replaced by a detachable locking plate 72 forming a receiving slot serving as a releasable grip. The locking plate 72 includes slotted tabs 74 extending downwardly from locking plate edges 76 and received in slots 78 formed in a platform 82 forming part of a lift gate 84 mounted to a transport vehicle. The pallet truck forks 30 are positioned between the slots 78 formed in the lift gate platform 82 and the locking plate is positioned over the forks 30 with the tabs 74 inserted into the slots 78. Once the locking plate 72 is slipped horizontally to secure the locking plate 72 to the lift gate platform 82, an operator raises the forks 30 to engage the forks 30 with the locking plate 72 to secure the pallet truck to the lift gate 84. As shown in FIG. 7, the pallet truck handle 20 is then folded over the pallet truck 10 to minimize the pallet truck height while being transported. Of course a second releasable grip, such as the pins 44 described above and received in apertures formed in the tabs 74 to further secure the pallet truck 10 to the lift gate 84 can be provided without departing from the scope of the invention.

As shown in FIG. 8, powered pallet trucks transported by a transporting vehicle secured to the transporting vehicle using releasable grips 36, 48, 72 such as described above, include an electrical system 92 having a rechargeable battery 94. The battery 94 powers the powered pallet truck, as schematically shown in FIG. 8. A charging port 96 proximal a lift gate supporting the forked vehicle is electrically connected to an electrical system 98 of the transporting vehicle. The charging port 96 is electrically connected to the powered lift truck battery 94 via a detachable electrical cable to selectively charge the battery 94 during transport of the powered lift truck.

In a preferred embodiment, an electrical module 102 in the pallet truck electrical system 92 controls the battery charging, such that the battery 94 is selectively charged based upon the current charge state of the battery 94 and/or only when the transporting vehicle engine is operating. In an alternative embodiment, an induction coil disposed in the lift gate inductively connects with an induction coil in the pallet truck to supply a charging current to the battery.

While there has been shown and described what is at present considered the preferred embodiment of the invention, it will be obvious to those skilled in the art that various changes and modifications can be made therein without departing from the scope of the invention defined by the following claims.

We claim:

1. A forked vehicle comprising:
a frame;
at least one fork extending from said frame; and
a releasable grip extending from at least one of said frame and said at least one fork, said releasable grip engagable with a lift gate and securing said forked vehicle relative to said lift gate.

2. The forked vehicle as in claim 1, including a handle extending from said frame, said handle being foldable over said frame.

3. The forked vehicle as in claim 1, including a handle extending from said frame, wherein at least a portion of said handle is separable from said frame.

4. The forked vehicle as in claim 1, wherein said forked vehicle is a pallet truck.

5. A vehicle assembly comprising:
a transporting vehicle;
a powered lift gate supported by said transporting vehicle;
a forked vehicle having at least one fork; and
a releasable grip securing said forked vehicle relative to said lift gate, said releasable grip being fixed relative to one of said lift gate and said forked vehicle, and said releasable grip engaging the other of said lift gate and forked vehicle to secure said forked vehicle relative to said lift gate.

6. The vehicle assembly as in claim 5, in which said transporting vehicle includes a transporting vehicle electrical system, and said forked vehicle includes a rechargeable battery, wherein said transporting vehicle electrical system charges said rechargeable battery.

7. The vehicle assembly as in claim 6, including a charging port mounted on said transporting vehicle proximal said powered lift gate, said charging port being electrically connected to said transporting vehicle electrical system and said rechargeable battery to charge said rechargeable battery.

8. The vehicle assembly as in claim 5, in which said forked vehicle includes a handle, said handle being at least one of foldable over said lift gate and at least a portion of said handle being separable from said forked vehicle.

9. The vehicle assembly as in claim 5, including at least one receiving slot fixed to said lift gate, and said at least one fork being received in said receiving slot.

10. The vehicle assembly as in claim 9, in which said releasable grip is a pin extending from one of said at least one fork and said at least one receiving slot, said pin extending into an aperture formed in the other of said at least one fork and said at least one receiving slot.

11. The vehicle assembly as in claim 9, in which said receiving slot is a releasable grip engaging said at least one fork.

12. The vehicle assembly as in claim 11 in which said receiving slot is a locking plate detachably fixed to said lift gate, wherein said locking plate extends over and engages said at least one fork to secure said forked vehicle relative to said lift gate.

13. The vehicle assembly as in claim 5 including at least two releasable grips securing said forked vehicle relative to said lift gate, wherein at least one of said releasable grips is 1) at least one of a pin extending from one of said forked vehicle and said at least one receiving slot, said pin extending into an aperture formed in the other of said forked vehicle and said at least one receiving slot and 2) a receiving slot engaging said at least one fork.

14. A method of securing a forked vehicle to a transporting vehicle; said method comprising:
inserting at least one fork of a forked vehicle into a receiving slot fixed to a transporting vehicle; and
securing the forked vehicle relative to the transporting vehicle by actuating a releasable grip.

15. The method as in claim 14, in which securing the forked vehicle relative to the transporting vehicle by actuating a releasable grip includes extending a pin from one of said forked vehicle and said receiving slot into an aperture formed in the other of said forked vehicle and said receiving slot.

16. The method as in claim 14, in which securing the forked vehicle relative to the transporting vehicle by actuating a releasable grip includes raising said at least one fork into engagement with a surface of said receiving slot.

17. The method as in claim 14, including charging a rechargeable battery on said forked vehicle through a transporting vehicle electrical system.

18. The method as in claim 17, in which said rechargeable battery is charged through a charging port electrically connected to said transporting vehicle electrical system.

19. The method as in claim 14, including folding a handle extending from said forked vehicle over said forked vehicle.

20. The method as in claim 14, including removing at least a portion of a handle extending from said forked vehicle from said forked vehicle.
